(19) United States
(12) Patent Application Publication
(10) Pub. No.: US 2026/0267688 A1
(43) Pub. Date: Sep. 10, 2026

(54) Automated routine platform

(71) Applicant: Distyl AI, Inc., San Francisco, CA (US)

(72) Inventors: Karime Maamari, Los Angeles, CA (US); Jenn Gamble, Redwood City, CA (US); David Lisuk, Brooklyn, NY (US); Derek Ho, New York, NY (US); Yonas Tesfaye, Redwood City, CA (US); David Roth, Brooklyn, NY (US); Connor Landy, Austin, TX (US); Will Morley, Brooklyn, NY (US)

(21) Appl. No.: 19/392,625

(22) Filed: Nov. 18, 2025

Related U.S. Application Data
(63) Continuation of application No. PCT/US25/52685, filed on Oct. 27, 2025.
(60) Provisional application No. 63/712,453, filed on Oct. 26, 2024.

(51) Int. Cl. G06F 9/48

(52) U.S. Cl. CPC G06F 9/4881

(57) ABSTRACT

Embodiments include systems and methods for automated routine generation and execution. In some embodiments, the method includes receiving a request to automate a target workflow; retrieving at least one document relevant to the target workflow from a knowledge base; generating a plurality of candidate routines based on the at least one document using a first machine learning model; generating an aggregate routine based on the plurality of candidate routines, the aggregate routine comprising instructions for automatically implementing the target workflow; mapping at least one step of the aggregate routine to at least one function configured to provide external functionality to a second machine learning model; and executing the aggregate routine using the second machine learning model, the step of executing the aggregate routine including calling the at least one function

### CROSS-REFERENCE TO RELATED APPLICATIONS

The present application is a continuation of International (PCT) Patent Application No. PCT/US 2025/052685, filed internationally on Oct. 27, 2025, and claims the benefit of and priority to U.S. Provisional Application No. 63/712,453 , filed on Oct. 26, 2024. The entire disclosure of each of these applications is hereby incorporated by reference as if set forth in their entirety herein.

### TECHNICAL FIELD

Embodiments described herein generally relate to systems and methods for an automated routine platform, and more particularly but not exclusively, to systems and methods for automated routine generation and execution using large language models.

### BACKGROUND

Enterprises today rely on a wide variety of systems, processes, and documentation to manage complex workflows, such as claims processing, order fulfillment, compliance verification, and customer service operations. These workflows are often described in a variety of documentation, such as internal guides, troubleshooting steps, training manuals, and/or policy documents. Conventional process automation techniques often rely on robotic process automation (RPA) systems or rule-based systems. These techniques, however, require significant technical expertise to implement, are expensive to maintain, and tend to break when workflows change or contain ambiguous requirements.

Large language models (LLMs) offer a promising alternative to generating and executing automated workflows, referred to as routines, thanks to their extensive capabilities to interpret natural language instructions, generate structured outputs, and learn from feedback over time. These capabilities allow LLMs to create routines that are adaptable, maintainable by non-technical users, and capable of handling variance without breaking.

Accordingly, there exists a need for improved methods and systems for automated routine generation.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, the techniques described herein relate to a computer-implemented method for automated routine generation and execution, the method being executed by a processing system including at least one processor and memory, the method including: receiving a request to automate a target workflow; retrieving at least one document relevant to the target workflow from a knowledge base; generating a plurality of candidate routines based on the at least one document using a first machine learning model; generating an aggregate routine based on the plurality of candidate routines, the aggregate routine including instructions for automatically implementing the target workflow; mapping at least one step of the aggregate routine to at least one function configured to provide external functionality to a second machine learning model; and executing the aggregate routine using the second machine learning model, the step of executing the aggregate routine including calling the at least one function.

In some embodiments, the method further includes automatically verifying at least one candidate routine before generating the aggregate routine.

In some embodiments, the step of mapping the at least one step of the aggregate routine uses a third machine learning model.

In some embodiments, the method further includes generating an intermediate representation of the target workflow based on the at least one document, wherein the plurality of candidate routines are generated based on the intermediate representation.

In some embodiments, the retrieving the at least one document includes: generating text embeddings for a plurality of documents at the knowledge base; and performing a similarity search on the text embeddings to identify the at least one document.

In some embodiments, at least one of the first or second machine learning models includes a large language model.

In some embodiments, the plurality of candidate routines include conflicting steps generated based on conflicting information from the at least one document.

In some embodiments, the method further includes receiving feedback for the aggregate routine, the feedback including at least one of user feedback or automated feedback generated based on simulated conversations; and updating the aggregate routine based on the feedback.

In some embodiments, the executing the aggregate routine includes: identifying an initial step for the aggregate routine; identifying at least one initial function for achieving the initial step; calling the at least one initial function; determining that the expected outcome of the initial step has been achieved; and identifying a subsequent step for the aggregate routine.

In some embodiments, the mapping the at least one step of the aggregate routine includes: determining that the at least one step of the aggregate routine does not map to any existing functions; and generating the at least one function based on the determination.

In some embodiments, the at least one function includes a function definition, a code stub, and a mock response.

In some embodiments, the external functionality includes accessing data at an external database via an executed database query.

In another aspect, the techniques described herein relate to a system for automated routine generation and execution, including: memory storing instructions; and a processor executing the instructions to perform the steps of: receiving a request to automate a target workflow; retrieving at least one document relevant to the target workflow from a knowledge base; generating a plurality of candidate routines based on the at least one document using a first machine learning model; generating an aggregate routine based on the plurality of candidate routines, the aggregate routine including instructions for automatically implementing the target workflow; mapping at least one step of the aggregate routine to at least one function configured to provide external functionality to a second machine learning model; and executing the aggregate routine using the second machine learning model, the step of executing the aggregate routine including calling the at least one function.

In some embodiments, the processor is further configured to perform the step of automatically verifying at least one candidate routine before generating the aggregate routine.

In some embodiments, the step of mapping the at least one step of the aggregate routine uses a third machine learning model.

In some embodiments, the processor is further configured to perform the step of generating an intermediate representation of the target workflow based on the at least one document, wherein the plurality of candidate routines are generated based on the intermediate representation.

In some embodiments, at least one of the first or second machine learning models includes a large language model.

In some embodiments, the plurality of candidate routines include conflicting steps generated based on conflicting information from the at least one document.

In some embodiments, the processor is further configured to perform the steps of: receiving feedback for the aggregate routine, the feedback including at least one of user feedback or automated feedback generated based on simulated conversations; and updating the aggregate routine based on the feedback.

In yet another aspect, the techniques described herein relate to a computer program product embodied in a non-transitory computer readable storage medium and including computer instructions for: receiving a request to automate a target workflow; retrieving at least one document relevant to the target workflow from a knowledge base; generating a plurality of candidate routines based on the at least one document using a first machine learning model call; generating an aggregate routine based on the plurality of candidate routines; mapping at least one step of the aggregate routine to at least one function configured to provide external functionality to at least one machine learning model; and executing the aggregate routine using a second machine learning model call, the step of executing the aggregate routine including calling the at least one function.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for automated routine generation in accordance with one embodiment.

FIG. 2 illustrates a flowchart of a method for automated routine generation in accordance with one embodiment.

FIG. 3 illustrates a routine step definition in accordance with one embodiment.

FIG. 4 illustrates a routine in accordance with one embodiment.

FIG. 5 illustrates a flowchart of another method for automated routine generation in accordance with one embodiment.

FIG. 6 illustrates a flowchart of a method for function mapping in accordance with one embodiment.

FIG. 7 illustrates a flowchart of a method for feedback driven editing in accordance with one embodiment.

FIG. 8 illustrates a flowchart of a method for conversation driven editing in accordance with in one embodiment.

FIG. 9 illustrates a flowchart of a method for routine execution in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

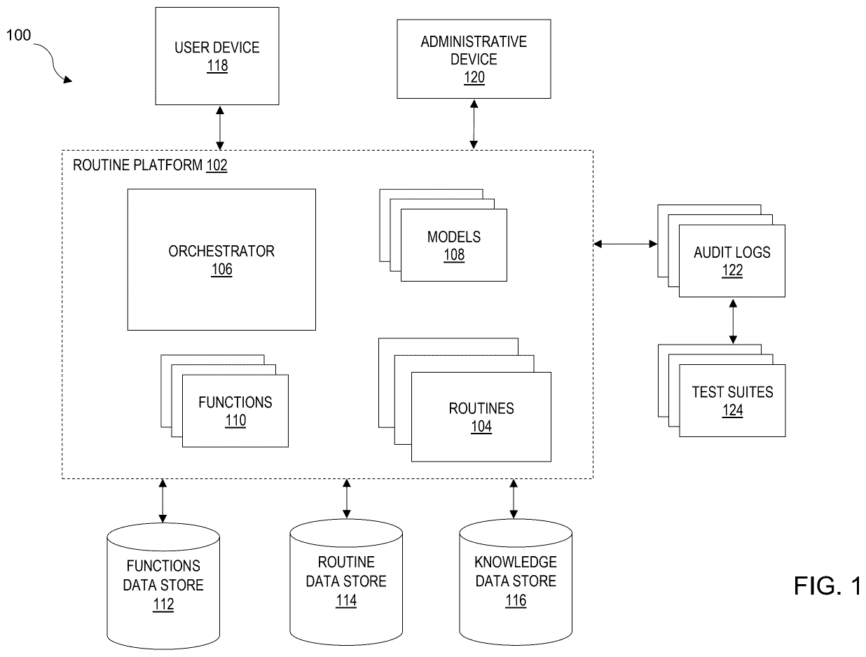

FIG. 1 illustrates a system 100 for automated routine generation in accordance with one embodiment. The system 100 may include any number of components for performing operations related to structured language query generation.

In some embodiments, the system 100 may include a routine platform 102 configured to perform various tasks related to routines 104. For example, the routine platform 102 may generate, edit, and/or monitor the routines 104. The routine platform 102 may be hosted on any suitable computing environment, such as a cloud server or an on-premises computing environment. The routine platform 102 may include an orchestrator 106 configured to manage and/or direct the operations of the routine platform 102. For example, the orchestrator 106 may direct the generation of the routines 104.

The routines 104 may be structured workflows configured to be automatically executed by at least one model to automatically implement a target workflow and achieve an objective, such as a business objective. Each routine 104 may include a sequence of routine steps providing instructions (e.g., natural language instructions) for executing the routine. Each routine step may be defined by a routine step definition containing various fields. For example, a routine step definition may comprise at least one of an identifier (e.g., a name), a description, (e.g., why the routine step is relevant to the routine), an expected outcome, functions available to the routine step, a conversational flag (e.g., a flag indicating whether user interactions are need during execution), and/or available next steps (e.g., potential routine steps that may follow the routine step).

In some embodiments, the routine platform 102 may perform various tasks using models 108. For example, the models 108 may be configured to generate and/or execute the routines 104 (e.g., as directed by the orchestrator 106). The routine step definitions of the routines 104 may provide natural language instructions for the models 108 to execute the routines 104. The models 108 may be configured to implement one or more decision tree learning algorithms, association rule learning algorithms, artificial neural network learning algorithms, deep learning algorithms, bitmap algorithms, and/or any other suitable data analysis technique. In some embodiments, the models 108 may include machine learning models. For example, the models 108 may include neural networks such as deep convolutional neural networks (CNN) using internal memories of its respective kernels (filters), recurrent neural networks (RNN), and/or long/short term memory neural networks (LSTM). The models 108 may be multi-layer models. For example, a model 108 may be implemented by a neural network that includes an input layer, one or more hidden layers, and an output layer. In some embodiments, the models 108 may include a large language model (LLM) trained on large bodies of text. The models 108 may be trained on texts related to workflows and/or routines.

In some embodiments, the routines 104 may be executed using functions 110. The functions 110 may include units of executable components (e.g., pieces of code) that provide the models 108 with external functionality, such as by providing access to external systems and/or data. The functions 110 may be stored at a functions data store 112 (e.g., as function definitions).

In some embodiments, each function 110 may be defined by a function definition, which may include at least one field for describing the corresponding function. For example, a function definition may include a name, a description (e.g., the task that the function performs), and at least one parameter (e.g., inputs to the function). As an example, a function for getting an item price may have a function definition including “get_price” as a name, “retrieves item price” as a description, and “item_identifier” as a parameter.

In some embodiments, the generated routines 104 may be stored at a routine data store 114 (e.g., as routine definitions) for execution at a later point in time. For example, the orchestrator 106 may direct at least one model 108 to execute one of the stored routines 104 in response to a request to execute a routine. The models 108 may call at least one function 110 during execution of the requested routine 104.

In some embodiments, the routine data store 114 may be a version-controlled data store, such as a versioned SQL table, a distributed blob storage system, and/or a git repository. Updates to a routine and/or executions of routine steps may be logged and stored at the routine data store 114. For example, each routine entry in the routine data store 114 may include routine metadata such as version identifiers, creation or update timestamps, authors, update descriptions, and/or authentication artifacts. The routine data store 114 may allow retrieval of prior routine versions, thereby enabling auditability and controlled rollback of prior releases.

In some embodiments, the routine platform 102 may generate the routines 104 using documents stored at a knowledge data store 116. The knowledge data store 116 may store documents related to the operations of an entity, such as papers, records, and/or logs. For example, the knowledge base may include internal guides, troubleshooting steps, training manuals, policy and/or compliance documents, collaborative documentation, data dictionaries, regulatory filings, glossaries, and/or scientific publications. The knowledge base may provide contextual information needed to generate the routines 104.

In some embodiments, the system 100 may include a user device 118. The user device 118 may include any type or form of device that a user can interact with to perform one or more functions or operations. Exemplary user devices may include, but are not limited to, smartphones, tablets, personal computers (e.g., laptops, desktops, etc.), smartwatches, fitness trackers, and/or television sets.

In some embodiments, the user device 118 may allow a user to interact with other components of the system 100, such as the routine platform 102. The user may be aiming to accomplish objectives by executing routines. The user device 118 may present a user interface (e.g., via an executing application) for allowing the user to interact with the rest of the system 100. The user interface may receive inputs from the user, such as a request to execute a routine or user feedback regarding an executed routine. The user interface may be presented using any suitable application, such as containerized applications, web programs, deployment tools, security services, data services, database applications, and/or data analytics platforms.

In some embodiments, the system 100 may include an administrative device 120. The administrative device 120 may include any type or form of device that an administrator may interact with to perform one or more functions or operations. Exemplary administrative devices may include, but are not limited to, smartphones, tablets, personal computers (e.g., laptops, desktops, etc.), smartwatches, fitness trackers, and/or television sets.

In some embodiments, the administrative device 120 may allow an administrator of the system 100 to interact with other components of the system 100, such as the routine platform 102. The administrative device 120 may present an administrative interface for allowing the administrator to interact with the components. The administrative interface may receive inputs from the user, such as a request to automate a target workflow or administrative feedback regarding a generated or executed routine. The administrative interface may be presented using any suitable application, such as containerized applications, web programs, deployment tools, security services, data services, database applications, and/or data analytics platforms.

In some embodiments, the system 100 may include components for monitoring and testing the operation of the system 100, such as audit logs 122 and test suites 124. The audit logs 122 may include logs of events related to the system 100, such as function calls, error events, test results, model outputs, user interactions, and/or routine updates. The logs may include various metadata related to the events, such as timestamps and/or user identifiers. In some embodiments, the audit logs 122 may be stored in the routine data store 114. The test suites 124 may include input scenarios and expected outputs for evaluating the correctness of the routines 104 and/or functions 110. In some embodiments, a suitable individual (e.g., a user and/or administrator) may input feedback during the testing process to provide feedback.

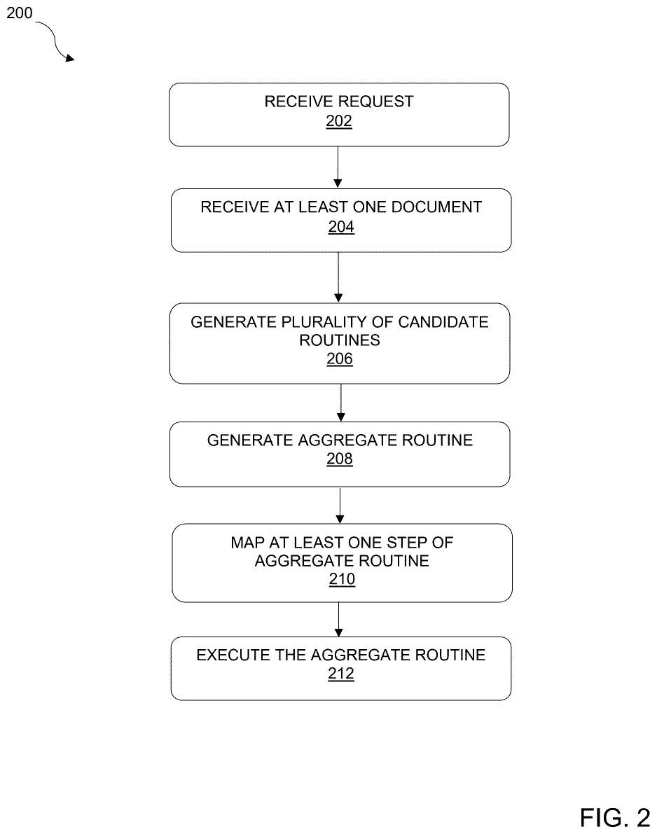

FIG. 2 illustrates a flowchart of a method 200 for automated routine generation in accordance with one embodiment. While FIG. 2 shows illustrative operations according to one embodiment, other embodiments may omit, add to, reorder, and/or modify any of the operations depicted in FIG. 2. Moreover, each of the operations depicted in FIG. 2 may be performed in any of the ways described herein. The operations depicted in FIG. 2 may be performed by any of the illustrative systems described herein, such as the system 100. For example, any of the operations may be performed at and/or directed by the orchestrator 106. Any of the operations depicted in FIG. 2 may be performed using a machine learning model, such as an LLM, via a model call.

Operation 202 may include receiving a request to automate a target workflow. The request may be received from any suitable individual, such as a user, an administrator of the system 100, and/or a subject matter expert. As used herein, a subject matter expert may include any individual with specialized domain expertise related to a target workflow. A subject matter expert may lack technical or scientific expertise while still possessing specialized domain expertise. The target workflow may be a workflow that the individual would like to automate to achieve a objective. The request may include a natural language description of the target workflow, such as a natural language description of the desired workflow steps. An exemplary request may be “handle damaged delivery using standard returns process.”

Operation 204 may include retrieving at least one document relevant to the target workflow from a knowledge base. The knowledge base may be stored at a data store, such as the knowledge data store 116. The knowledge base may be any suitable set of organizational documents relevant to performing workflows, such as papers, records, and/or logs. For example, the knowledge base may include internal guides, troubleshooting steps, training manuals, policy and/or compliance documents, collaborative documentation, data dictionaries, regulatory filings, glossaries, and/or scientific publications. The knowledge base may be continuously updated to include new information. For example, subject matter experts may regularly provide new information to the knowledge base.

In some embodiments, the knowledge base may contain domain-specific information, such as definitions of terminology or practices that are specific to the corresponding domain. For example, in the financial domain, the domain-specific documents may specify standardized definitions of metrics such as “quarter-over-quarter growth” or “return per viewer.” In this manner, the knowledge base may provide appropriate contextual information for the request.

The relevant document may be retrieved using any suitable technique. In some embodiments, for example, the retrieval may include using a map-reduce framework to perform distributed processing of raw documents at the knowledge base.

In some embodiments, the retrieval may include an embeddings-based similarity search. The request and the documents in the knowledge base may be converted into vector embeddings. Each embedding may indicate the contextual and syntactic meaning of the corresponding text. The embeddings may be generated using transformer-based encoders. The embeddings of the documents may be compared to the embedding of the request using a similarity search (e.g., cosine similarity, inner-product correlation, etc.). Embeddings with the highest similarity values may be identified as embeddings of relevant documents. In some embodiments, the identified embeddings may be grouped into clusters, such as semantic clusters that capture particular aspects or stages of the target workflow.

In some embodiments, the retrieval may include performing governance-based filtering during identification. For example, documents marked by a policy as restricted, obsolete, and/or confidential may be automatically excluded or masked.

In some embodiments, the retrieval may include at least one preprocessing task for the knowledge base documents. For example, the preprocessing task may include standardizing heterogenous data formats, tagging documents with metadata, removing boilerplate text, and/or performing optical character recognition for scanning documents.

Operation 206 may include generating a plurality of candidate routines. In some embodiments, a first machine learning model (e.g., one of the models 108) may be configured to generate the candidate routines based on the relevant document and the request (e.g., using the natural language description of the target workflow and contextual information from the relevant document). The model may generate the candidate routines via a model call (e.g., an LLM call).

Each candidate routine may include routine steps for automatically performing the target workflow. The candidate routines may capture potential workflow paths reflected in the relevant documents. In some embodiments, the candidate routines may capture conflicting workflow paths based on conflicting documents. For example, a first document may indicate that a return order should be fulfilled immediately upon receipt while a second document may indicate that the return order should be verified first before fulfillment. A first candidate routine may reflect the first document, and a second candidate routine may reflect the second document.

In some embodiments, the model may be configured to generate the candidate routines based on an intermediate representation of the target workflow. The intermediate representation may be a summary of the target workflow based on the relevant documents. For example, the intermediate representation may include natural language descriptions of various characteristics of the target workflow, such as workflow steps, desired objectives, decision points, and/or available functions. The intermediate representation may serve as a condensed version of the relevant document and the request, thus improving downstream processing efficiency.

Operation 208 may include generating an aggregate routine based on the candidate routines. In some embodiments, the first machine learning model (and/or any other machine learning model) may be configured to generate the aggregate routine.

In some embodiments, a machine learning model may identify a subset of the candidate routines, such as a single candidate routine. For example, the model may comprise an evaluator model configured to evaluate the candidate routines and identify the subset based on the evaluation. Any suitable evaluation criteria may be used, such as correctness, complexity (e.g., the number of nodes for a routine), logical consistency, and/or conversational quality or tone. The model may determine a score for each candidate routine and identify the subset based on the scores. Candidate routines with the highest scores (e.g., routines with scores exceeding a threshold, the routine with the highest score, etc.) may be used to generate the aggregate routine. In some embodiments, a discriminator model and an evaluator model may be used

In some embodiments, the model may resolve conflicts between the candidate routines, such as conflicting paths. For example, the model may incorporate conflicting paths as multiple conditional branches in the aggregate routine. In some examples, the model may select the path that best aligns with the target workflow (e.g. by analyzing the intermediate representation) and/or appears more often in the document.

In some embodiments, the model may merge complementary information between the candidate routines. For example, one candidate routine may specify particular functions needed for the routine steps, while another candidate routine may specify next potential steps in detail. The two candidate routines may be combined to incorporate the functions and the next potential steps.

In some embodiments, the model may eliminate redundancies between the candidate routines. For example, two candidate routines may include the same routine step. The model may recognize this redundancy and generate a single routine step from the redundancy.

Operation 210 may include mapping at least one step of the aggregate routine to at least one function. The function may provide external functionality to the aggregate routine by providing access to external systems and/or data. For example, the function may be a data retrieval function that retrieves data from a database, or an action function that performs an action (e.g., using an API call). The step may be mapped based on a determination that executing the step would require access to external functionality.

Operation 212 may include executing the aggregate routine. In some embodiments, a second machine learning model (and/or any other suitable model) may be configured to execute the aggregate routine. The model may execute the aggregate routine via a model call (e.g., an LLM call). In some embodiments, the execution may be based on a request to execute the aggregate routine, such as a request from a user.

In some embodiments, the aggregate routine may be executed at an interactive environment, such as a live interactive conversational environment. The environment may present a conversational interface through which a user may interact with the routine in real time. The environment may allow user input via the interface, such as user requests, additional information, confirmations, and/or feedback. For example, the user can request for the execution of the aggregate routine via the interface. In some embodiments, the interactive environment may be used based on at least one step of the aggregate routine having a conversational flag.

In some embodiments, the aggregate routine may be executed automatically without user interaction. For example, the aggregate routine may be executed using automated batch processing.

In some embodiments, executing the aggregate routine may include calling the function. For example, the model may perform a function call after determining that the function is required to execute the aggregate routine. The function call may be defined by a function name and at least one function parameter. For example, a function call for retrieving an item price with the item ID “0004” may be defined by the string “get_item_price(0004).” The function call may be mapped to a function executor (e.g., a piece of code, a SQL template, an API, etc.), which executes the function and returns the output to the model. For example, to execute a data retrieval function, the function call may be mapped to a SQL template, which is used to execute a SQL query against a SQL database. The appropriate data may be retrieved from the database and returned to the model. To execute an action function, the function call may be mapped to an API or a piece of code. Depending on the mapping, an API call may be performed or the piece of code may be executed.

In some embodiments, any of the outputs related to the method 200 may be evaluated. The evaluations may be performed following any of the operations of the method 200. For example, automated evaluations may be performed to verify the correctness of the candidate routines and/or aggregate routine (e.g., after operation 210). The evaluations may use test suites (e.g., the test suites 124) to test the outputs against expected outcomes and flag any of the outputs for errors. In some embodiments, the evaluations may include hallucination checks to determine whether the models outputted any hallucinations. In some embodiments, the evaluations may include manual feedback from users and/or administrators. The evaluations may be logged using audit logs, which may be stored in appropriate data stores.

In some embodiments, at least one remediation action may be performed based on the evaluations. For example, an edited version of the aggregate routine may be generated and/or the aggregate routine may be directly edited (e.g., by prompting an administrator to directly modify the aggregate routine at a user interface). Any aspect of the method 200 may be modified to generate the edited aggregate routine, such as by updating model parameters, updating function mappings, and/or updating the knowledge base. The evaluations may be provided as input to a model (e.g., the second machine learning model), which may learn and update its parameters based on the evaluations. Edited routines may be repeatedly subjected to further evaluations until the routines are approved (e.g., by the administrator).

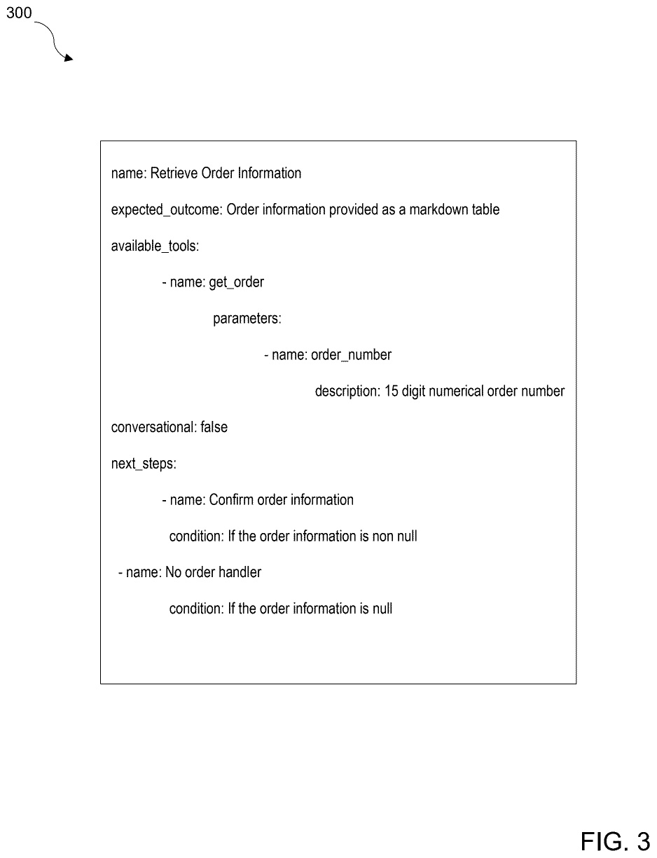

FIG. 3 illustrates a routine step definition 300 in accordance with one embodiment. As described above, the routine step definition 300 may contain various fields for defining a routine step. For example, the routine step definition 300 may contain a routine name, an expected outcome, available tools, a conversational flag, and available next steps. As shown, the routine step definition 300 may define a routine step named “Retrieve Order Information.” The expected outcome of the routine step may be outputting order information. The conversational flag of the routine step may be set to false, meaning that live user input is not expected during execution of the routine. The available next steps may be “confirm order information” and “no order handler.” As shown, each available next step may be associated with a condition indicating when the corresponding next step should be selected.

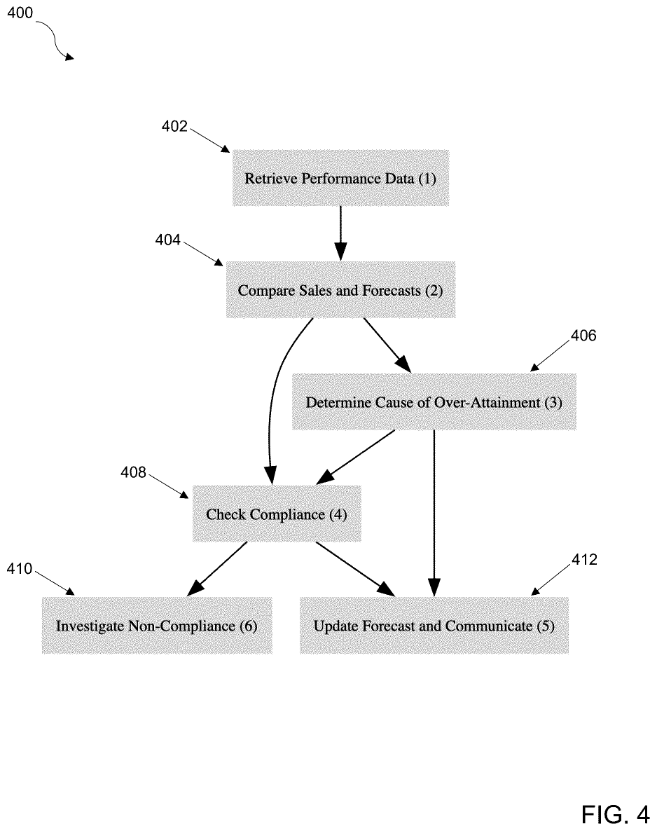

FIG. 4 illustrates a routine 400 in accordance with one embodiment. The routine 400 may be constructed as a graph structure, such as a directed graph. The nodes of the graph structure may correspond to routine steps, such as routine steps 402 to 412. The edges may correspond to transitions between routine steps. In this manner, the routine 400 may include multiple possible execution paths, with the actual execution paths determined based on the conditions of the edges. For example, one possible execution of the routine 400 may include executing routine steps 402, 404, 408, and 410 in order.

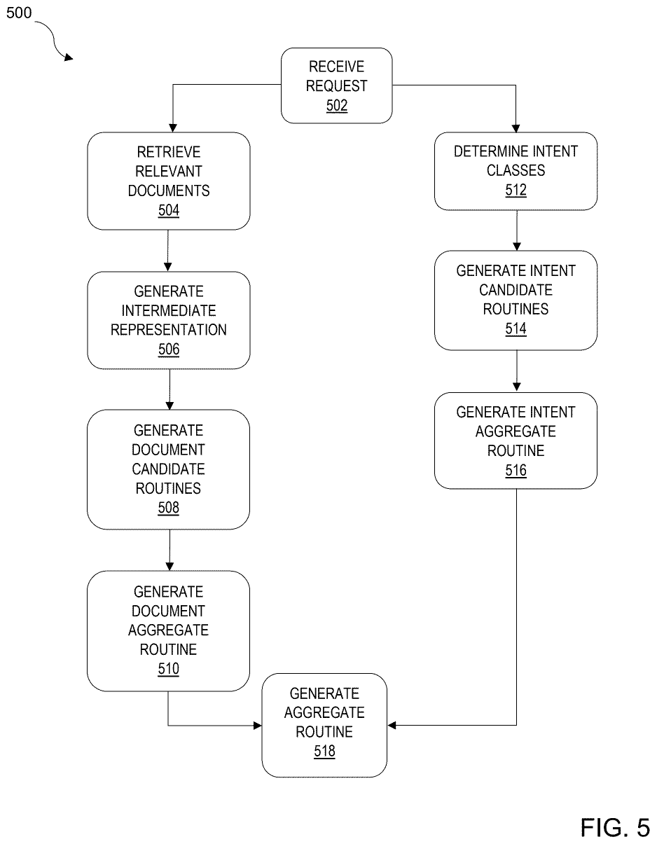

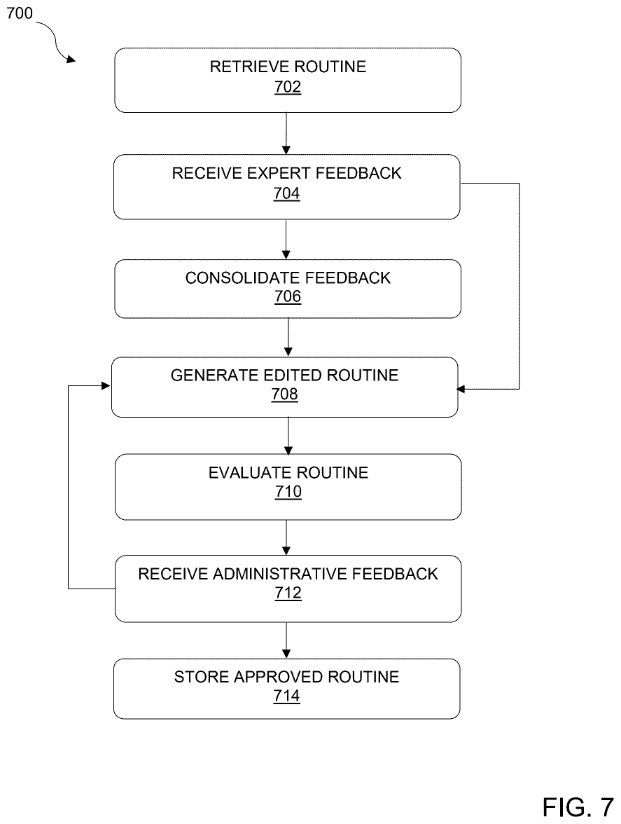

FIG. 5 illustrates a flowchart of a method 500 for automated routine generation in accordance with one embodiment. While FIG. 5 shows illustrative operations according to one embodiment, other embodiments may omit, add to, reorder, and/or modify any of the operations depicted in FIG. 5. Moreover, each of the operations depicted in FIG. 5 may be performed in any of the ways described herein. The operations depicted in FIG. 5 may be performed by any of the illustrative systems described herein, such as the system 100. For example, any of the operations may be performed at and/or directed by the orchestrator 106. Any of the operations depicted in FIG. 7 may be performed using a machine learning model, such as an LLM.

Operation 502 may include receiving a request to automate a target workflow. Operation 502 may be similar to operation 202 in the method 200.

In some embodiments, multiple routine generation processes may be performed based on the request. As shown, for example, a document-based generation process may include operations 504 to 510, and an intent-based generation process may include operations 512 to 516. The document-based generation process may be similar to the routine generation process depicted in FIG. 2.

Operation 504 may include retrieving at least one document relevant to the target workflow from a knowledge base. Operation 504 may be similar to operation 204.

Operation 506 may include generating an intermediate representation based on the relevant document and the request. The intermediate representation may be a natural language summary of the target workflow and contextual information extracted from the relevant document. The contextual information may describe any suitable aspect of the target workflow, such as step sequences, decision conditions, entity roles, exception handling logic, and/or data relationships.

Operation 508 may include generating a plurality of document candidate routines based on the intermediate representation. Operation 508 may be similar to operation 206 in the method 200. The document candidate routines may be similar to the candidate routines in the method 200.

Operation 510 may include generating a document aggregate routine. Operation 508 may be similar to operation 208 in the method 200. The document aggregate routine may be similar to the aggregate routine in the method 200.

Operation 512 may include determining a plurality of intent classes associated with the target workflow. The intent classes may classify a set of documents associated with the target workflow, such as logs of prior conversations and/or workflow guidelines. Each intent class may correspond to a particular intent associated with the target workflow. Each intent may represent a high-level purpose, goal, and/or topic. For example, the set of documents may be classified into a “returns” intent class and a “billing” intent class.

Operation 514 may include generating a plurality of intent candidate routines based on the intent classes. A separate intent candidate routine may be generated for each intent class. Each intent candidate routine may be generated similarly to that of the document aggregate routine. For example, relevant documents may be retrieved for a particular intent class. An intermediate representation may be generated based on the relevant documents. A plurality of candidate routines may be generated based on the intermediate representation. An intent candidate routine corresponding to the intent class may be generated based on the candidate routines.

Operation 516 may include generating an intent aggregate routine based on the intent candidate routines. The intent aggregate routine may be generated from the intent candidate routines similarly to that of the document aggregate routine from the candidate routines in operation 510.

Operation 518 may include generating an aggregate routine based on the document aggregate routine and intent aggregate routine. The document aggregate routine and intent aggregate routine may be combined or aggregated to form the aggregate routine. In some embodiments, the aggregate routine may undergo a self-consistency check to ensure that the aggregate routine behaves as a single coherent process with logical and semantic integrity.

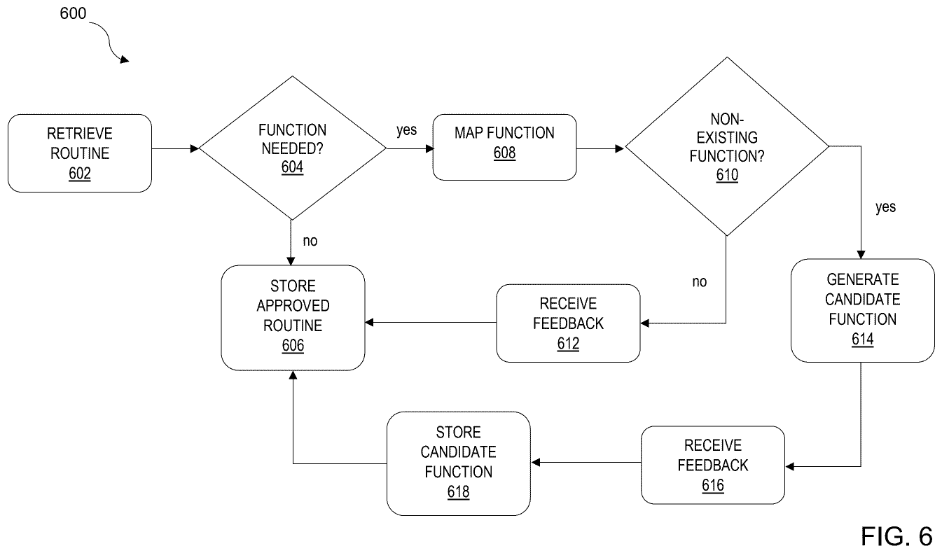

FIG. 6 illustrates a flowchart of a method 600 for function mapping in accordance with one embodiment. While FIG. 6 shows illustrative operations according to one embodiment, other embodiments may omit, add to, reorder, and/or modify any of the operations depicted in FIG. 6. Moreover, each of the operations depicted in FIG. 6 may be performed in any of the ways described herein. The operations depicted in FIG. 6 may be performed by any of the illustrative systems described herein, such as the system 100. Any of the operations depicted in FIG. 6 may be performed using a machine learning model, such as an LLM, via a model call.

Operation 602 may include retrieving at least one routine. The routine may be generated using any of the methods described herein, such as methods 200 and/or 500. The routine may be generated by a model, such as the models 108. Any number of routines may be processed simultaneously and/or in succession.

Operation 604 may include determining whether at least one step of the routine requires a function to execute. In some embodiments, operation 604 may be performed using a machine learning model, such as an LLM. The model may be configured to determine steps that require external functionality, such as retrieving external data. The model may analyze the routine step definitions and determine whether the expected outcome of each step cannot be accomplished via internal systems alone.

If no steps require any functions, then no functions need to be mapped, and the method 600 may proceed to operation 606. Operation 606 may include storing the routine as is (e.g., at the routine data store 114). If at least one step requires a function, the method 600 may proceed to operation 608. Operation 608 may include mapping at least one existing function to the step. The existing function may be retrieved from a functions data store, such as the functions data store 112.

In some embodiments, operation 608 may be performed using a machine learning model. For example, the model may perform a similarity mapping between the routine step and functions at the functions data store. The model may use existing routines as guidance, such as by identifying existing routines with similar steps to the step being mapped. The model may map the step to at least one function mapped to the similar steps.

Operation 610 may include determining whether at least one step of the routine requires a non-existing function. If not, then the method 600 may proceed to operation 612. Operation 612 may include receiving feedback regarding the mapped routine, such as from a user and/or administrator. The mapped routine may require approval before proceeding to operation 606. Disapproved routines may undergo further evaluations until approved.

If at least one step requires a non-existing function, then the method 600 may proceed to operation 614. Operation 614 may include generating at least one candidate function for the step. In some embodiments, operation 614 may be performed using a machine learning model.

The candidate function may include various types of data for defining the candidate function. For example, the candidate function may include a function definition, a code stub, and/or a mock response. As described above, the function definition may include various fields for defining the function. The code stub may be a piece of code for executing the function. The mock response may include representative sample data that the function would return if executed. The mock response may be based on examples in the routine source data and/or routine steps.

In some embodiments, every step that requires a non-existing function may be considered together for generating the candidate function. For example, multiple steps may require the same or a similar non-existing function. The candidate function may be mapped to each of the multiple steps. This may avoid unnecessarily generating duplicate functions.

Operation 616 may include receiving feedback regarding the candidate function, such as from a user and/or administrator. The candidate function may require approval before proceeding to operation 618. Operation 618 may include storing the candidate function. The candidate function may be stored at a functions data store (e.g., the functions data store 112) for mapping future routines. The method 600 may then proceed to operation 606 as described above.

As described above, generated routines may be evaluated and edited based on the evaluations. The evaluations may be performed using any suitable method. For example, the evaluations may be performed using feedback driven editing and/or simulated conversation driven editing. Feedback driven editing may include processes where the routines are edited based on feedback from suitable individuals. Conversation driven editing may include processes where the routines are edited based on live conversational interactions (e.g., with an automated agent). In some embodiments, the routines may be iteratively evaluated and/or edited until a satisfactory routine is generated (e.g., a routine with an error-free evaluation).

In some embodiments, the evaluations may be performed without the need for interactions with technical experts such as engineers, technicians, and/or scientists. In such embodiments, the interactions may be solely from non-technical individuals such as subject matter experts, users, and/or administrators. This may allow the evaluation process to be more scalable and cost-efficient, as users may edit routines and update routine processes in real-time without external resources.

In some embodiments, the edits may be made in real-time, allowing users to preview and test changes immediately. For example, when a user edits a routine, a visualization of the edited routine may be presented at a user interface. In some embodiments, a temporary version of the routine may be complied and executed it in a sandbox environment. The resulting routine behavior and outputs may be presented, enabling iterative fine-tuning without the need for redeployment. Once approved, the edited routine may be stored for future executions.

FIG. 7 illustrates a flowchart of a method 700 for feedback driven editing in accordance with one embodiment. While FIG. 7 shows illustrative operations according to one embodiment, other embodiments may omit, add to, reorder, and/or modify any of the operations depicted in FIG. 7. Moreover, each of the operations depicted in FIG. 7 may be performed in any of the ways described herein. The operations depicted in FIG. 7 may be performed by any of the illustrative systems described herein, such as the system 100. For example, any of the operations may be performed at and/or directed by the orchestrator 106. Any of the operations depicted in FIG. 7 may be performed using a machine learning model, such as an LLM, via a model call.

Operation 702 may include retrieving a generated routine. The routine may be generated by performing any of the methods described herein, such as the method 200 and/or method 500. For example, the routine may have been generated using at least one model and stored at a routine data store, such as the routine data store 114. In some embodiments, the routine may have already undergone at least one evaluation, such as verifying the correctness of candidate routines used to generate the routine and/or functions mapped to routine steps.

Operation 704 may include receiving expert feedback regarding the generated routine. The expert feedback may be received from at least one subject matter expert and/or any other suitable individual. The expert feedback may include qualitative feedback (e.g., description of errors, missing details, desired edits, etc.) and/or quantitative feedback (e.g., error rates, user satisfaction scores, objective completion rates, etc.). The expert feedback may be received via a user interface.

Operation 706 may include consolidating the expert feedback. The expert feedback may include feedback from multiple subject matter experts. In such cases, the expert feedback may be consolidated, such as by grouping similar feedback entries and/or resolving conflicts between subject matter experts. For example, conflicting feedback may be resolved by selecting feedback provided by the most number of experts and/or feedback provided by the most reputable experts.

In some embodiments, the entries in the consolidated feedback may be associated with confidence weights. The entries may be ranked based on the confidence weights. It is to be appreciated, however, that the expert feedback may not require any consolidation (e.g., the expert feedback is from one expert). In this case, operation 706 may not be performed.

Operation 708 may include generating an edited routine based on the consolidated feedback. The edits may include any suitable edit to the routine, such as adding new steps, deleting steps, changing function mappings, and/or using different knowledge documents. The edits may be presented to suitable individuals in real-time.

Operation 710 may include evaluating the routine. The evaluations may be performed using any of techniques described herein, such as automated evaluations using test suites.

Operation 712 may include receiving administrative feedback regarding the edited routine. The administrative feedback may be from at least one administrator and/or any other suitable individual. The administrative feedback may include any of the feedback described herein, such as descriptions of errors or desired edits. In some embodiments, the administrative feedback may indicate administrative approval of the edited routine.

In some embodiments, the edited routine may be iteratively updated until the administrator approves of the routine. As shown, for example, disapproved routines may repeatedly undergo operations 708 to 712. Operation 714 may include storing approved routines (e.g., at a routine data store such as the routine data store 114).

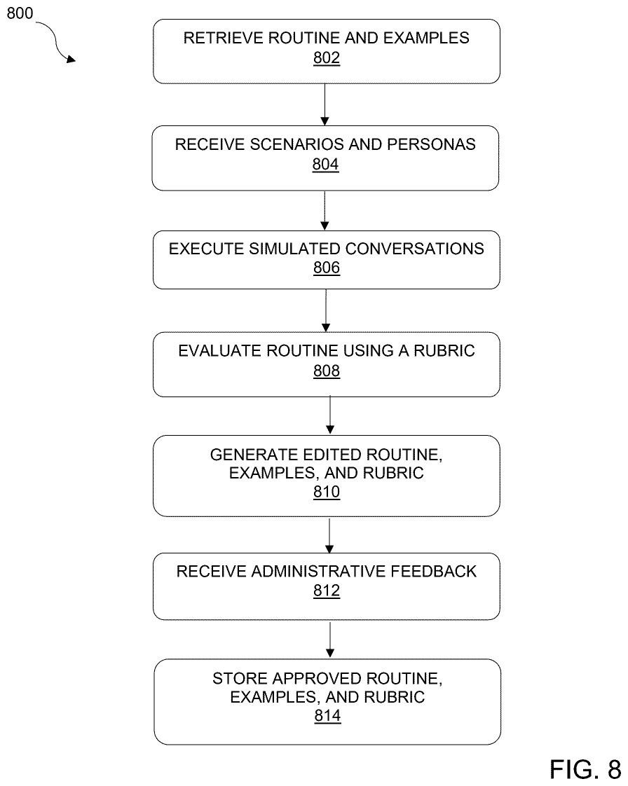

FIG. 8 illustrates a flowchart of a method 800 for conversation driven editing in accordance with in one embodiment. While FIG. 8 shows illustrative operations according to one embodiment, other embodiments may omit, add to, reorder, and/or modify any of the operations depicted in FIG. 8. Moreover, each of the operations depicted in FIG. 8 may be performed in any of the ways described herein. The operations depicted in FIG. 8 may be performed by any of the illustrative systems described herein, such as the system 100. For example, any of the operations may be performed at and/or directed by the orchestrator 106. Any of the operations depicted in FIG. 8 may be performed using a machine learning model, such as an LLM, via a model call.

Operation 802 may include retrieving a routine and at least one example related to the routine. The example may indicate the expected behavior of the routine in simulated conversations, such as expected outcomes, expected conversational exchanges, expected steps, expected functions, and/or expected decision logic. The example may be created manually by a suitable individual (e.g., a subject matter expert) and/or generated automatically (e.g., from past routine executions or knowledge documents).

Operation 804 may include retrieving at least one scenario and at least one persona. The scenario may define the conditions for testing the routine. The persona may define the characteristics of a simulated user interacting with the routine. The persona may correspond to a particular user archetype, such as a first-time user or an experienced expert.

In some embodiments, the scenario and/or persona may be created by a suitable individual, such as a subject matter expert or administrator. The scenario and/or persona may be retrieved from a set of stored scenarios and personas. The stored scenarios and personas may be stored as clusters corresponding to different categories of scenarios and simulated users. For example, the stored personas may be clustered by age, gender, career, and/or domain expertise. The retrieved scenario and/or persona may be selected based on the desired conversation coverage, such as coverage over a particular age range.

Operation 806 may include executing at least one simulated conversation. The simulated conversation may represent a simulated dialogue session between the routine and the simulated user. The simulated conversation may be generated based on the scenario and/or persona. In some embodiments, a separate simulated conversation may be generated for each possible scenario-persona combination. For example, six simulated conversations may be generated if two scenarios and three personas are retrieved.

Operation 808 may include evaluating the routine. The evaluation may be similar to any of the evaluations described herein. The evaluation may be based on live data collected from the simulated conversation, such as user responses and/or system responses. In some embodiments, a rubric may define the evaluation methodology, such as the criteria, criteria weights, and/or evaluation thresholds. Suitable criteria may include, but are not limited to, correctness, completeness, conversation tone, clarity, policy compliance, and/or response latency. The rubric may be used to generate a quantitative score (e.g., a normalized score between 0 and 1) and/or qualitative annotations. In some embodiments, the rubric may be selected from a set of rubrics based on the routine and/or simulated conversation.

Operation 810 may include generating an edited routine, rubric, and/or example based on the evaluation. The edits may include any suitable edit. For example, edits to the routine may include adding new steps to the routine, deleting steps from the routine, changing function mappings for routine steps, and/or using different knowledge documents to generate the routine. Edits to the rubric may include adjusting criteria, adjusting criteria weights, and/or adjusting evaluation thresholds. Edits to the example may include generating examples to cover new scenarios and/or removing examples deemed irrelevant or unnecessary. The edits may be presented to suitable individuals in real-time.

Operation 812 may include receiving administrative feedback regarding the edited routine, rubric, and/or example. The administrative feedback may be from at least one administrator and/or any other suitable individual. The administrative feedback may include any of the feedback described herein, such as descriptions of errors or desired edits. In some embodiments, the administrative feedback may indicate administrative approval of the edited routine, rubric, and/or example.

In some embodiments, the edited routine, rubric, and/or example may be iteratively updated until the administrator approves of the routine, rubric, and/or example. As shown, for example, the edited routine may repeatedly undergo operations 808 to 812. Operation 814 may include storing the approved routine, rubric, and/or example (e.g., at a routine data store such as the routine data store 114).

In some embodiments, the conversation driven editing process shown in FIG. 8 may be combined with the feedback driven editing process shown in FIG. 7. For example, a generated routine may undergo feedback driven editing and conversation driven editing in sequence and/or in parallel. In a parallel configuration, human feedback and simulation data may be aggregated and provided as input for the routine evaluations. In this manner, generated routines may be improved through both human insight and large-scale simulation data. A suitable individual (e.g., an administrator) may select how the conversation driven editing process and feedback driven editing process are combined.

In some embodiments, a particular editing process may be selected based on at least one characteristic of a generated routine, such as the conversational flag, the availability of human feedback, and/or the age of the routine. For example, conversation driven editing may be selected for a newly generated routine with a conversational flag and a lack of associated subject matter experts.

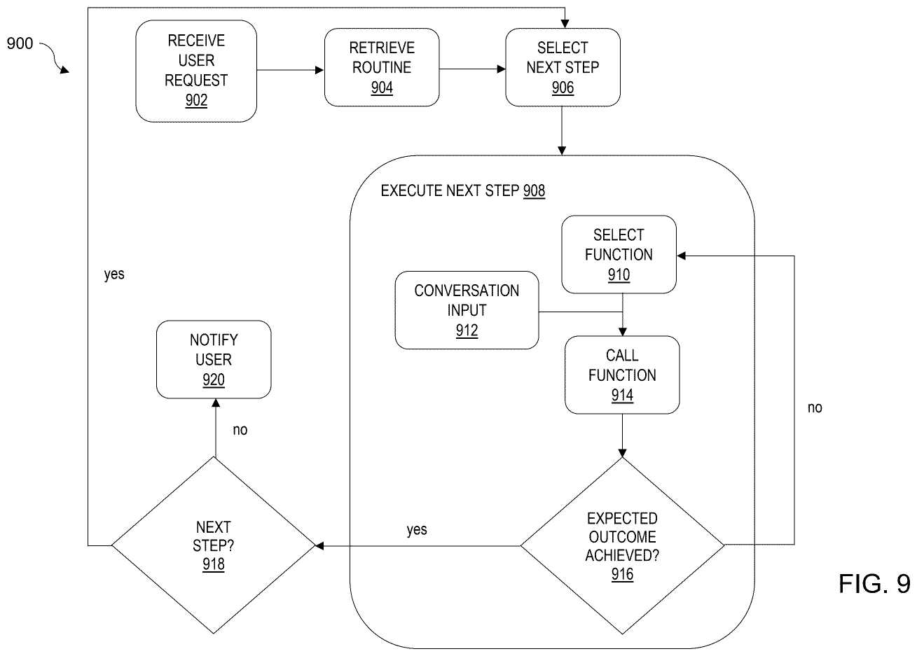

FIG. 9 illustrates a flowchart of a method 900 for routine execution in accordance with one embodiment. While FIG. 9 shows illustrative operations according to one embodiment, other embodiments may omit, add to, reorder, and/or modify any of the operations depicted in FIG. 9. Moreover, each of the operations depicted in FIG. 9 may be performed in any of the ways described herein. The operations depicted in FIG. 9 may be performed by any of the illustrative systems described herein, such as the system 100. For example, any of the operations may be performed at and/or directed by the orchestrator 106. Any of the operations depicted in FIG. 7 may be performed using a machine learning model, such as an LLM, via a model call.

Operation 902 may include receiving a user input. The user input may be received at a user interface presented at a user device, such as the user device 118. The user input may include any suitable input requiring some response or action. For example, the user input may include a user query (e.g., for a routine, an item, etc.), an administrative command, an order submission, and/or a customer service request. For example, the request may include the instruction “check order status” or the instruction “file a claim.”

Operation 904 may include retrieving a routine based on the user input. The user input may be parsed to identify a routine matching the user input. The routine may be retrieved from a set of available routines stored at a routine data store. The routine may be retrieved based on the input intent, metadata associated with the request, user context, and/or similarity matching against available routines. For example, a user query stating “generate a financial report for last quarter” may be matched to a routine for generating financial reports. In some embodiments, the routine may be a validated routine that has undergone at least one evaluation and/or editing (e.g., via feedback driven editing and/or conversation driven editing).

Operation 906 may include selecting the next unexecuted routine step of the routine. The initial routine step may be the first step selected for execution.

Operation 908 may include executing the selected step. The selected step may be executed by a machine learning model, such as an LLM. As shown, the operation 908 may include various sub-operations, such as sub-operations 910 to 916. Sub-operation 910 may include selecting least one function mapped to the selected step. Sub-operation 912 may include receiving conversational input from the user if the selected step is a conversational step. The conversational input may include any suitable user input, such as user requests, additional information, confirmations, and/or feedback. For example, the conversational input may include user confirmation to execute the selected step, contextual information, user modifications to the function, and/or a request to abort the execution of the function (e.g., after presenting a prompt to confirm execution). Sub-operation 914 may include calling the function. The machine learning model may perform a function call to call the function and receive an output of the function.

Operation 916 may include determining whether the expected outcome of the selected step has been achieved. If not, the method 900 may repeat the operation 908 (e.g., by looping back to sub-operation 910) until the expected outcome is achieved. When the expected outcome is achieved, the method 900 may proceed to operation 918, which may include determining whether there is a step after the selected step. If the expected outcome isn't achieved, then the method 900 may loop back to operation 906. At operation 906, the next step may be determined by selecting a next step among the available next steps. The next step may be selected based on a condition associated with the next step being satisfied. The method 900 may repeat operations 906 to 918 until there are no more steps to be executed. Once there are no more steps to be executed, the method 900 may proceed to operation 920. Operation 920 may include notifying the user that the routine has been fully executed.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A computer-implemented method for automated routine generation and execution, the method being executed by a processing system comprising at least one processor and memory, the method comprising:
receiving a request to automate a target workflow;
retrieving at least one document relevant to the target workflow from a knowledge base;
generating a plurality of candidate routines based on the at least one document using a first machine learning model;
generating an aggregate routine based on the plurality of candidate routines, the aggregate routine comprising instructions for automatically implementing the target workflow;
mapping at least one step of the aggregate routine to at least one function configured to provide external functionality to a second machine learning model; and
executing the aggregate routine using the second machine learning model, the step of executing the aggregate routine including calling the at least one function.

2. The computer-implemented method of claim 1, further comprising automatically verifying at least one candidate routine before generating the aggregate routine.

3. The computer-implemented method of claim 1, wherein the step of mapping the at least one step of the aggregate routine uses a third machine learning model.

4. The computer-implemented method of claim 1, further comprising generating an intermediate representation of the target workflow based on the at least one document, wherein the plurality of candidate routines are generated based on the intermediate representation.

5. The computer-implemented method of claim 4, wherein the retrieving the at least one document comprises:
generating text embeddings for a plurality of documents at the knowledge base; and
performing a similarity search on the text embeddings to identify the at least one document.

6. The computer-implemented method of claim 1, wherein at least one of the first or second machine learning models comprises a large language model.

7. The computer-implemented method of claim 1, wherein the plurality of candidate routines comprise conflicting steps generated based on conflicting information from the at least one document.

8. The computer-implemented method of claim 1, further comprising:
receiving feedback for the aggregate routine, the feedback comprising at least one of user feedback or automated feedback generated based on simulated conversations; and
updating the aggregate routine based on the feedback.

9. The computer-implemented method of claim 1, wherein the executing the aggregate routine comprises:
identifying an initial step for the aggregate routine;
identifying at least one initial function for achieving the initial step;
calling the at least one initial function;
determining that the expected outcome of the initial step has been achieved; and
identifying a subsequent step for the aggregate routine.

10. The computer-implemented method of claim 1, wherein the mapping the at least one step of the aggregate routine comprises:
determining that the at least one step of the aggregate routine does not map to any existing functions; and
generating the at least one function based on the determination.

11. The computer-implemented method of claim 1 wherein the at least one function comprises a function definition, a code stub, and a mock response.

12. The computer-implemented method of claim 1, wherein the external functionality comprises accessing data at an external database via an executed database query.

13. A system for automated routine generation and execution, comprising:
memory storing instructions; and
a processor executing the instructions to perform the steps of:
receiving a request to automate a target workflow;
retrieving at least one document relevant to the target workflow from a knowledge base;
generating a plurality of candidate routines based on the at least one document using a first machine learning model;
generating an aggregate routine based on the plurality of candidate routines, the aggregate routine comprising instructions for automatically implementing the target workflow;
mapping at least one step of the aggregate routine to at least one function configured to provide external functionality to a second machine learning model; and
executing the aggregate routine using the second machine learning model, the step of executing the aggregate routine including calling the at least one function.

14. The system of claim 13, wherein the processor is further configured to perform the step of automatically verifying at least one candidate routine before generating the aggregate routine.

15. The system of claim 13, wherein the step of mapping the at least one step of the aggregate routine uses a third machine learning model.

16. The system of claim 13, wherein the processor is further configured to perform the step of generating an intermediate representation of the target workflow based on the at least one document, wherein the plurality of candidate routines are generated based on the intermediate representation.

17. The system of claim 13, wherein at least one of the first or second machine learning models comprises a large language model.

18. The system of claim 13, wherein the plurality of candidate routines comprise conflicting steps generated based on conflicting information from the at least one document.

19. The system of claim 13, wherein the processor is further configured to perform the steps of:
receiving feedback for the aggregate routine, the feedback comprising at least one of user feedback or automated feedback generated based on simulated conversations; and
updating the aggregate routine based on the feedback.

20. A computer program product embodied in a non-transitory computer readable storage medium and comprising computer instructions for:
receiving a request to automate a target workflow;
retrieving at least one document relevant to the target workflow from a knowledge base;
generating a plurality of candidate routines based on the at least one document using a first machine learning model call;
generating an aggregate routine based on the plurality of candidate routines;
mapping at least one step of the aggregate routine to at least one function configured to provide external functionality to at least one machine learning model; and
executing the aggregate routine using a second machine learning model call, the step of executing the aggregate routine including calling the at least one function.
